(19) United States
(12) Patent Application Publication
(10) Pub. No.: US 2026/0166708 A1
(43) Pub. Date: Jun. 18, 2026

(54) Driving Tool with Rear Handle Storage Compartment and Kit

(71) Applicant: Milwaukee Electric Tool Corporation, Brookfield, WI (US)

(72) Inventors: Kyle A. Ritz, Burlington, WI (US); Kyle A. Tacoronte, Port Washington, WI (US); Christian R. Braun, Milwaukee, WI (US)

(21) Appl. No.: 19/433,336

(22) Filed: Dec. 26, 2025

Related U.S. Application Data
(63) Continuation of application No. PCT/US2025/059346, filed on Dec. 12, 2025.
(60) Provisional application No. 63/734,521, filed on Dec. 16, 2024.
(60) Provisional application No. 63/750,499, filed on Jan. 28, 2025.

(51) Int. Cl. B25G 1/08; B25B 13/06; B25B 13/46; B25B 15/00; B25B 23/00; B25B 23/16

(52) U.S. Cl. CPC B25G 1/085; B25B 13/06; B25B 13/46; B25B 15/00; B25B 23/0021; B25B 23/0035; B25B 23/16

(57) ABSTRACT

A driving tool is provided. The diving tool includes a handle and a channel extending along the length of the handle from a first end of the handle to a second end of the handle. An end cap is removably coupled to the second end of the handle. The end cap includes a shaft that extends through an opening of the channel and is positioned within the channel when the end cap is coupled to the second end of the handle. When the end cap is removed, the channel is configured to drive a fastener.

### CROSS-REFERENCE TO RELATED PATENT APPLICATIONS

The present application is a continuation of International Application No. PCT/US 2025/059346, filed on Dec. 12, 2025, which claims the benefit of and priority to U.S. Provisional Application No. 63/750,499, filed on Jan. 28, 2025, and U.S. Provisional Application No. 63/734,521, filed on Dec. 16, 2024, which are incorporated herein by reference in their entireties.

### BACKGROUND OF THE INVENTION

The present invention relates generally to the field of tools. The present invention relates specifically to a driving tool, such as a nut driver, screwdriver, etc., that includes storage for engagement bits, such as nut driving sockets, screwdriver bits, etc., within a compartment in the handle of the driving tool.

### SUMMARY OF THE INVENTION

One embodiment of the invention relates to a driving tool including a handle, a channel, and an end cap. The handle includes a first end, a second end opposite the first end along a longitudinal axis, and an outer surface extending between the first end and the second end. The channel is centered on the longitudinal axis and extends along the length of the handle from the first end of the handle to the second end of the handle. The outer surface of the handle circumferentially surrounds the channel with respect to the longitudinal axis. The channel includes a first opening located at the first end of the handle and a second opening opposite the first opening and located at the second end of the handle. The end cap is removably coupled to the second end of the handle. The end cap includes a shaft. The shaft extends through the second opening and is positioned within the channel when the end cap is coupled to the second end of the handle. When the end cap is removed, the channel is configured to drive a fastener.

Another embodiment of the invention relates to a driving tool including a handle, an end cap, and a channel. The handle includes a first end, a second end opposite the first end along a longitudinal axis, a body defining a cavity within the handle between the first end and the second end, and an opening at the first end of the handle. The body includes an outer surface circumferentially surrounding the cavity with respect to the longitudinal axis. The opening is centered on the longitudinal axis and configured to engage a driver accessory. The end cap is coupled to the second end of the handle. The end cap includes a shaft configured to engage and retain at least one engagement bit. The channel is formed along the handle and extends along the longitudinal axis from the opening through the cavity to the second end of the handle. When the end cap is removed, the channel is configured to engage a workpiece.

Another embodiment of the invention relates to a driving tool kit. The driving tool kit includes at least one driver accessory, at least one engagement bit, and a handle. The handle extends along a longitudinal axis. The handle includes a first end, a second end opposite the first end along the longitudinal axis, and an opening at the first end of the handle. The opening is configured to receive and retain at least one driver accessory. A channel extends along the longitudinal axis between the first end and the second end of the handle. The channel is surrounded by an outer surface of the handle. An end cap is removably coupled to the second end of the handle. The end cap includes a shaft extending into the channel of the handle when the end cap is coupled to the second end of the handle. The shaft is configured to receive and retain at least one engagement bit.

Additional features and advantages will be set forth in the detailed description which follows and will be readily apparent to those skilled in the art from the description or recognized by practicing the embodiments as described in the written description and/or shown in the accompanying drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of the driving tool with an end cap of the handle disconnected, according to an exemplary embodiment;

FIG. 2 is a side view of the driving tool of FIG. 1 with the socket accessory disconnected and the end cap of the handle removed, according to an exemplary embodiment;

FIG. 3 is a top perspective view of the driving tool of FIG. 1 with the socket accessory removed, according to an exemplary embodiment;

FIG. 4 is a top view of a driving tool, according to an exemplary embodiment;

FIG. 5 is a side view of a handle of a driving tool, according to an exemplary embodiment;

FIG. 6 is a side view of the handle of FIG. 5 with the cavity, the channel, the shaft of the end cap, and engagement bits mounted on the shaft shown in broken lines, according to an exemplary embodiment;

FIG. 7 is a detailed view of an engagement bit storage holder coupled to an end cap of the handle of FIG. 5, according to an exemplary embodiment;

FIG. 8 is a side view of a handle of a driving tool, according to an exemplary embodiment;

FIG. 9 is a detailed view of an engagement bit storage holder coupled to an end cap of the handle of FIG. 8, according to an exemplary embodiment;

FIG. 10 is a side view of a driving tool, according to an exemplary embodiment;

FIG. 11 is a side view of a driving tool, according to an exemplary embodiment;

FIG. 12 is a side view of a driving tool, according to an exemplary embodiment;

FIG. 13 is a side view of a driving tool, according to an exemplary embodiment;

FIG. 14 is a side view of a driving tool, according to an exemplary embodiment;

FIG. 15 is a side view of a driving tool, according to an exemplary embodiment;

FIG. 16 is a detailed view of the head of the driving tool of FIG. 15, according to an exemplary embodiment;

FIG. 17 is a side view of the head of FIG. 16, according to an exemplary embodiment;

FIG. 18 is a detailed view of a socket adapter of the driving tool of FIG. 15, according to an exemplary embodiment;

FIG. 19 is a detailed view of a head of a driving tool with a socket adapter, according to an exemplary embodiment;

FIG. 20 is a side view of the head of FIG. 19, according to an exemplary embodiment; and

FIG. 21 is a detailed view of a socket adapter, according to an exemplary embodiment.

### DETAILED DESCRIPTION

Referring generally to the figures, various embodiments of a driving tool and driving tool kit are shown. Applicant believes that the driving tools discussed herein provide various advantages over typical driving tools. Typical driving tools may be limited by the types of engagement bits that might be used with the driving tool (e.g., a screwdriver with screwdriver bits). As such, users who have a specific task to complete may need to bring multiple driving tools and/or numerous engagement bits to complete said task.

Applicant believes that the driving tools and driving tool kits discussed herein allow a user to minimize the number of tools carried to a task and provide storage for additional engagement bits. Specifically, the driving tools discussed herein include a handle including a body that defines a cavity within the handle for storing engagement bits. A channel extends along the length of the handle from a first end of the handle to a second end of the handle. This channel is configured to drive a fastener such that a user can utilize the handle as a pass-thru driver when the end cap is removed. That is, an inner surface of the channel defines a polygonal-shaped cross-section such that the inner surface can interface with and engage a fastener to drive the fastener along a workpiece.

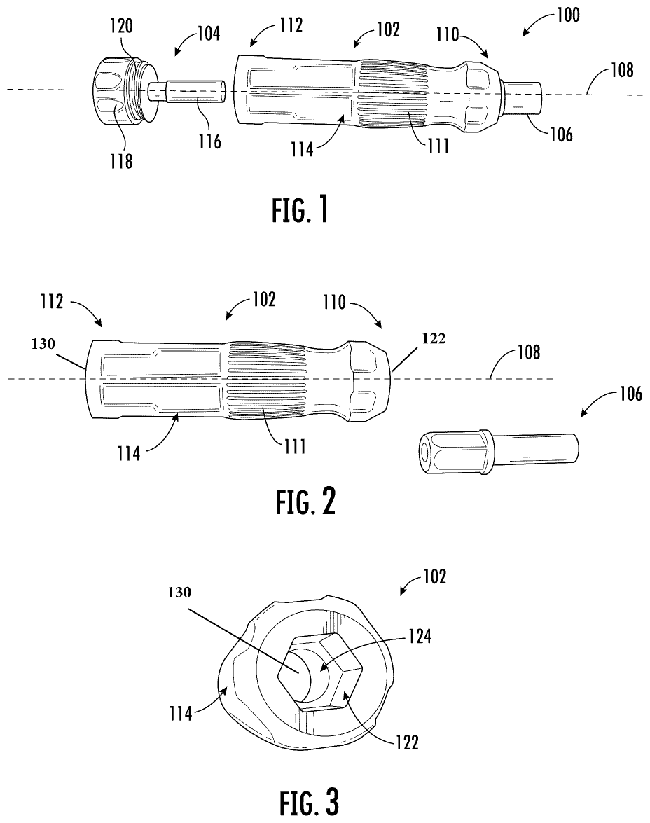

Referring to FIGS. 1-3, a driving tool 100 is shown and described. Driving tool 100 includes a handle 102, an end cap 104, and a driver accessory 106. In various embodiments, the driver accessory may be a screwdriver shank, a ratchet attachment, a handle extension, a socket adapter, an anvil drive, an engagement bit like a socket, or other driver attachment. Driver accessory 106 is configured to engage with an engagement bit, such as a screwdriver bit or nut driving socket, a workpiece, and/or another driver accessory.

Driving tool 100 extends along a longitudinal axis 108. Handle 102 is centered on and extends along longitudinal axis 108. Handle 102 includes a body 111 with a first or mounting end 110 and a second or rear end 112 opposite mounting end 110 along longitudinal axis 108. Body 111 has an outer surface 114. Outer surface 114 extends between rear end 112 and mounting end 110.

End cap 104 is configured to removably couple to rear end 112 of handle 102. End cap 104 includes a support shank or shaft 116 and a base 118. Shaft 116 extends away from base 118. When end cap 104 is coupled to handle 102, shaft 116 is positioned within handle 102 and is centered on and extends along longitudinal axis 108. Shaft 116 is configured to receive and retain engagement bits, such as screwdriver bits or nut driving sockets.

As shown, base 118 includes outer threaded surface 120 configured to engage with corresponding threading on an inner surface of rear end 112 to couple end cap 104 to handle 102. In various embodiments, end cap 104 may be coupled to handle 102 via internal threading on end cap 104 and external threading on rear end 112. In other various embodiments, end cap 104 may be coupled to handle 102 via and interference fit, such as a friction fit, press fit, or snap fit.

Referring to FIG. 3, handle 102 includes a first opening 122 located at mounting end 110 and a second opening 130 opposite first opening 122 and located at rear end 112. First opening 122 is centered on longitudinal axis 108 and is configured to receive and retain driver accessory 106. Driver accessory 106 is mounted in first opening 122. As shown, first opening 122 is a hexagonal shape. Second opening 130 is centered on longitudinal axis 108.

Handle 102 further includes a pass-through channel 124 extending from mounting end 110 to rear end 112. Channel 124 is formed along handle 102 and extends along longitudinal axis 108 from first opening 122 to rear end 112 and, more specifically, to second opening 130. Channel 124 is centered on longitudinal axis 108 and extends along the length of handle 102 from rear end 112 to mounting end 110. Outer surface 114 circumferentially surrounds channel 124 with respect to longitudinal axis 108. When end cap 104 is coupled to rear end 112, shaft 116 extends through second opening 130 and is positioned within channel 124. When end cap 104 is removed or decoupled from handle 102, channel 124 is configured to engage a workpiece. In a specific embodiment, channel 124 is configured to drive a fastener (e.g., a nut) along an elongate threaded workpiece (e.g., a rod or shaft) that is positioned within channel 124 and extends through handle 102 during use. That is, channel 124 and/or first opening 122 have an inner surface that define a polygonal-shaped cross-section. As shown, at least a portion of channel 124 defines a hexagonal shape that extends from opening 122 towards rear end 112 of handle 102.

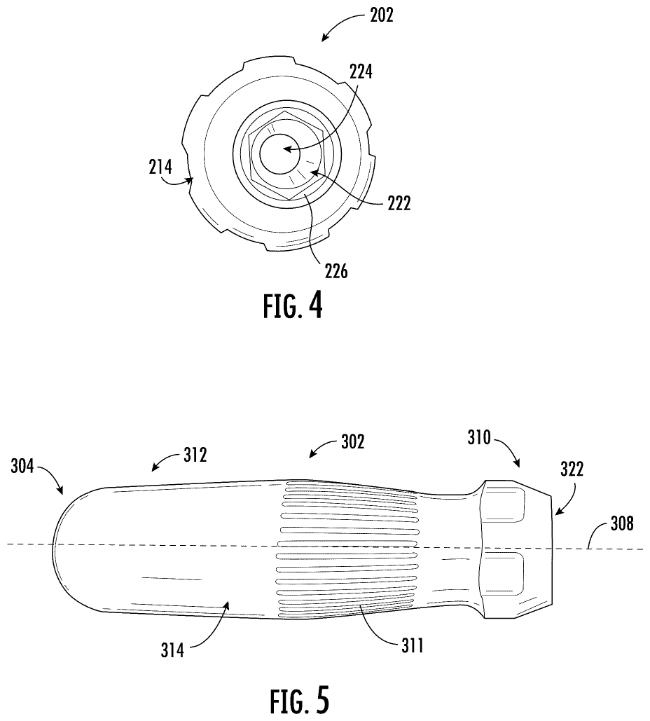

Referring to FIG. 4, a handle 202 is shown. Handle 202 may be used with a driving tool, such as driving tool 100. Handle 202 is substantially the same as handle 102 except for the differences discussed herein. Specifically, handle 202 includes an insert, shown as a hexagonal-shaped interface or hex interface 226, positioned within an opening 222. Hex interface 226 is configured to engage and retain driver accessories, such as a screwdriver shank, a screwdriver bit, sockets, etc. Hex interface 226 may retain driver accessories through an interference fit. Hex interface 226 may also be used to engage a workpiece when a workpiece is positioned within a channel 224. Hex interface 226 defines a width of opening 222. In a specific embodiment, the width is 9/16 inches.

Referring to FIGS. 5-7, a handle 302 is shown and described. Handle 302 may be used with a driving tool, such as driving tool 100. Handle 302 is substantially the same as handles 102 and 202, except for the differences discussed herein.

Handle 302 is centered on a longitudinal axis 308. Handle 302 includes a body 311, with a mounting end 310, rear end 312 opposite the mounting end 310 along longitudinal axis 308, and an outer surface 314 extending between mounting end 310 and rear end 312. Body 311 defines a cavity 328. Cavity 328 is centered on and extends along longitudinal axis 308. Outer surface 314 of body 311 defines cavity 328 between mounting end 310 and rear end 312. Outer surface 314 circumferentially surrounds cavity 328 with respect to longitudinal axis 308. A channel 324 extends from mounting end 310 through cavity 328 to rear end 312. In a specific embodiment, channel 324 extends between opening 322 and cavity 328.

Rear end 312 includes an opening 330 which provides access to cavity 328. Opening 330 is located opposite opening 322 and is centered on longitudinal axis 308. Opening 330 is configured to engage with an end cap 304. End cap 304 is coupled to handle 302 through opening 330. As shown, a base 318 of end cap 304 includes outer threaded surface 320 configured to engage with inner threaded surface 332 of rear end 312 to couple end cap 304 to handle 302. In various embodiments, end cap 304 may be coupled to handle 302 via internal threading on end cap 304 and external threading on rear end 312.

End cap 304 includes base 318 and a shaft 316. When end cap 304 is coupled to handle 302, shaft 316 is centered on and extends along longitudinal axis 308. When end cap 304 is coupled to handle 302, shaft 316 extends through opening 330 and is positioned within cavity 328. Shaft 316 is configured to receive and retain engagement bits, such as screwdriver bits 340, 341, and socket 342. When end cap 304 is coupled to rear end 312 of handle 302, the engagement bits are positioned within cavity 328. To access an engagement bit, a user removes end cap 304 from handle 302. The user may then select the desired engagement bit from shaft 316.

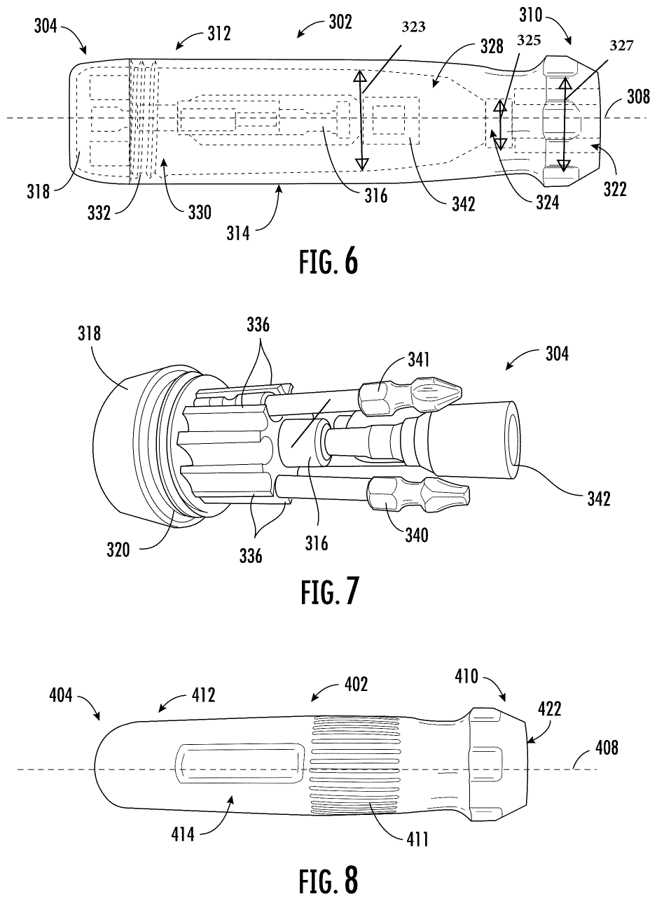

Referring to FIG. 6, cavity 328 has a first width 323 measured perpendicular to longitudinal axis 308, and channel 324 has a second width 325 measured perpendicular to longitudinal axis 308 in the same direction as first width 323. In a specific embodiment, first width 323 is greater than second width 325. In this way, cavity 328 is wider than channel 324. Opening 322 has a third width 327. In a specific embodiment, third width 327 is greater than second width 325. In another specific embodiment, cavity 328 defines a cross-sectional area measured perpendicular to longitudinal axis 308 that is greater than a cross-sectional area of channel 324 measured perpendicular to longitudinal axis 308. The cross-sectional area of channel 324 defines a shape. In a specific embodiment, the shape of the cross-sectional area of channel 324 is a different shape than the shape of opening 322. In a specific embodiment, opening 322 is a hexagonal shape and the cross-sectional area of channel 324 is a rounded shape (e.g., circle, oval, etc.).

Referring to FIG. 7, base 318 includes projections 336 used to receive and retain engagement bits. A shown, screwdriver bits 340, 341 are positioned between projections 336 and are positioned around shaft 316. Screwdriver bits 340, 341 are retained by projections 336 through an interference fit. In a specific embodiment, a pair of projections 336 are configured to retain an engagement bit, such as screwdriver bits 340, 341, on end cap 304, when the engagement bit is placed between the pair of projections. Socket 342 is mounted on an end of shaft 316. As shown, when end cap 304 is coupled to rear end 312 of handle 302, socket 342 is surrounded by outer surface 314 of handle 302 and is positioned along longitudinal axis 308.

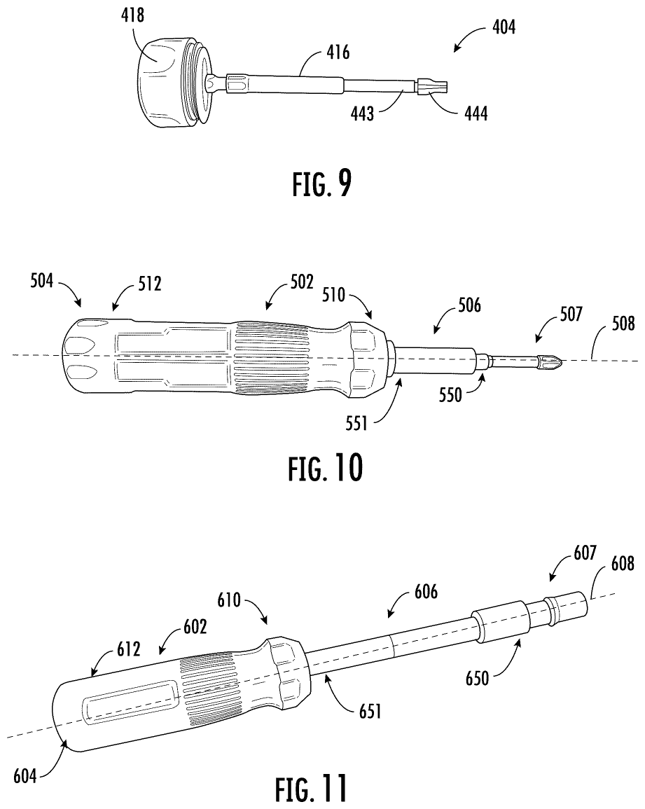

Referring to FIGS. 8-9, a handle 402 is shown and described. Handle 402 may be used with a driving tool, such as driving tool 100. Handle 402 is substantially the same as handles 102, 202, and 302, except for the differences discussed herein. Specifically, a shaft 416 of an end cap 404 has a tip 444. Tip 444 is configured to engage a workpiece (e.g., a fastener) such that end cap 404 may be used as an additional driving tool.

Handle 402 includes a mounting end 410 and a rear end 412 opposite mounting end 410 along a longitudinal axis 408. End cap 404 is removably coupled to rear end 412. End cap 404 includes a base 418 and shaft 416. Shaft 416 is coupled to base 418 and extends in a direction away from base 418. An end 443 of shaft 416 includes a tip 444. Tip 444 is configured to engage a workpiece. As shown, tip 444 is structured like the tip of a screwdriver and is configured to engage a fastener like a screw. More specifically, end cap 404 is configured so that a user may use end cap 404 like a stubby screwdriver when end cap 404 is disconnected from handle 402.

Referring to FIGS. 10-15, various driving tool kits are shown and described. The driving tool kits each include a handle, at least one driver accessory, and at least one engagement bit. With these driving tool kits, users can select engagement bits and driver accessories that are desired for a specific task. In various embodiments, additional engagement bits may be stored in the handle. In other various embodiments, the handle may include a channel, which allows the handle to be used as a pass-through driver.

Referring to FIG. 10, a driving tool kit 500 is shown. Driving tool kit 500 includes a handle 502, and an end cap 504. Handle 502 is substantially the same as handles 102, 202, 302, and 402. End cap 504 is substantially the same as end caps 104, 204, 304, and 404. Driving tool kit 500 also includes a driver accessory, shown as handle extension 506, and an engagement bit, shown as screwdriver bit 507.

End cap 504 is removably coupled to handle 502 at second or rear end 512. Handle extension 506 is mounted on first or mounting end 510 of handle 502. Handle extension 506 includes a first end 550 and a second end 551 opposite first end 550. Second end 551 is coupled to mounting end 510 of handle 502. When handle extension 506 is coupled to mounting end 510 of handle 502, first end 550 extends in a direction along longitudinal axis 508 away from mounting end 510 and rear end 512. First end 550 is configured to receive and retain an engagement bit, such as screwdriver bit 507.

Referring to FIG. 11, a driving tool kit 600 is shown. Driving tool kit 600 is substantially the same as driving tool kit 500, except for the differences discussed herein. Specifically, driving tool kit 600 includes a driver accessory, shown as socket extender 606.

Driving tool kit 600 includes a handle 602, an end cap 604, socket extender 606, and an engagement bit, shown as socket 607. End cap 604 is removably coupled to handle 602 at second or rear end 612. Socket extender 606 is mounted on first or mounting end 610 of handle 602. Socket extender 606 includes a first end 650 and a second end 651 opposite first end 650. Second end 651 is coupled to mounting end 610 of handle 602. First end 650 extends away from mounting end 610 and away from rear end 612 in a direction along longitudinal axis 608. First end 650 is configured to receive and retain an engagement bit, such as socket 607.

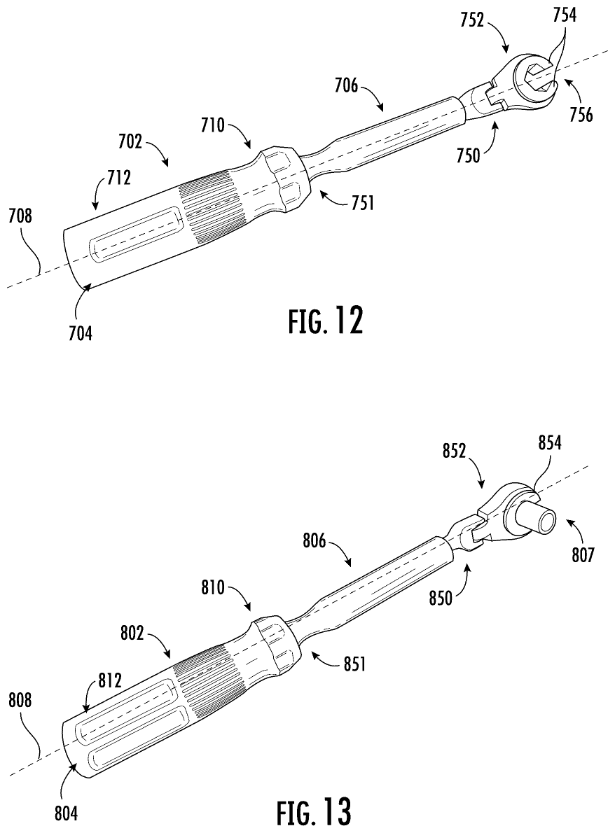

Referring to FIG. 12, a driving tool kit 700 is shown. Driving tool kit 700 is substantially the same as driving tool kits 500 and 600, except for the differences discussed herein. Specifically, driving tool kit 700 includes a driver accessory, shown as ratchet wrench attachment 706.

Driving tool kit 700 includes a handle 702, an end cap 704, and ratchet wrench attachment 706. Ratchet wrench attachment 706 is removably coupled to a mounting end 710 of handle 702. Ratchet wrench attachment 706 includes a first end 750 and a second end 751 opposite first end 750. A head 752 of ratchet wrench attachment 706 is located at first end 750. Head 752 is configured to engage a workpiece (such as a fastener) or an engagement bit. Head 752 includes a jaw 754 that defines an opening 756. An engagement bit or workpiece can be inserted into head 752 during use.

Referring to FIG. 13, a driving tool kit 800 is shown. Driving tool kit 800 is substantially the same as driving tool kits 500, 600, and 700, except for the differences discussed herein. Specifically, driving tool kit 800 includes an engagement bit, shown as socket 807 positioned within an opening 856 of a driver accessory, shown as ratchet wrench attachment 806.

Driving tool kit 800 includes a handle 802, an end cap 804, ratchet wrench attachment 806, and socket 807. Ratchet wrench attachment 806 is removably coupled to a mounting end 810 of handle 802. Ratchet wrench attachment 806 includes a head 852 located at a first end 850 of ratchet wrench attachment 806. Head 852 includes a jaw 854 that defines opening 856. Socket 807 is received and retained within opening 856. Socket 807 is configured to engage a workpiece (such as a fastener).

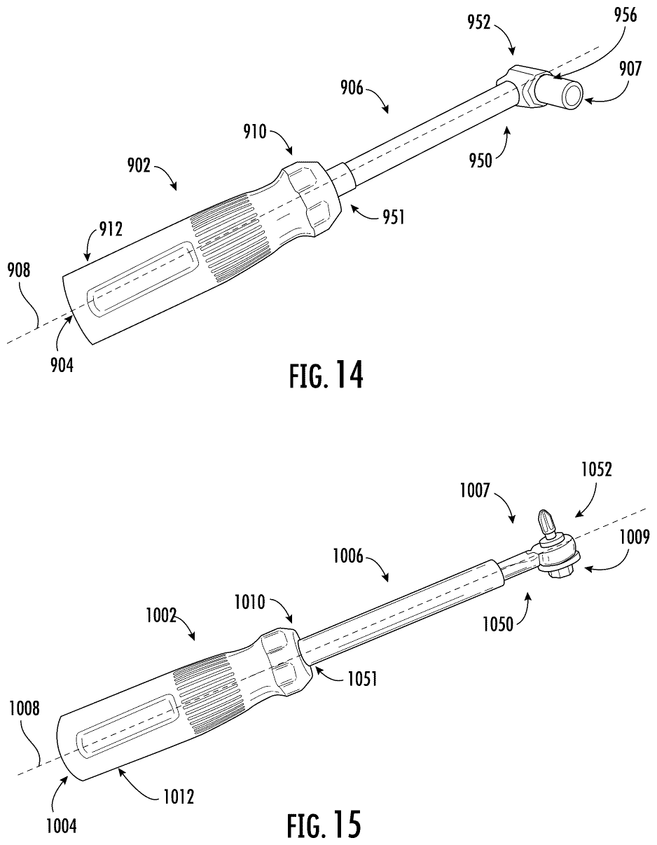

Referring to FIG. 14, a driving tool kit 900 is shown. Driving tool kit 900 is substantially the same as driving tool kits 500, 600, 700, and 800, except for the differences discussed herein. Specifically, driving tool kit 900 includes a driver accessory, shown as socket driver attachment 906.

Driving tool kit 900 includes a handle 902, an end cap 904, socket driver attachment 906, and an engagement bit shown as socket 907. Socket driver attachment 906 is removably coupled to a mounting end 910 of handle 902. Socket driver attachment 906 includes a first end 950 and a second end 951 opposite first end 950. A head 952 of socket driver attachment 906 is located at first end 950. Head 952 defines an opening or channel 956. Channel 956 is configured to receive and retain an engagement bit, such as socket 907. Socket 907 is coupled to head 952 and is configured to receive and engage a workpiece (such as a fastener).

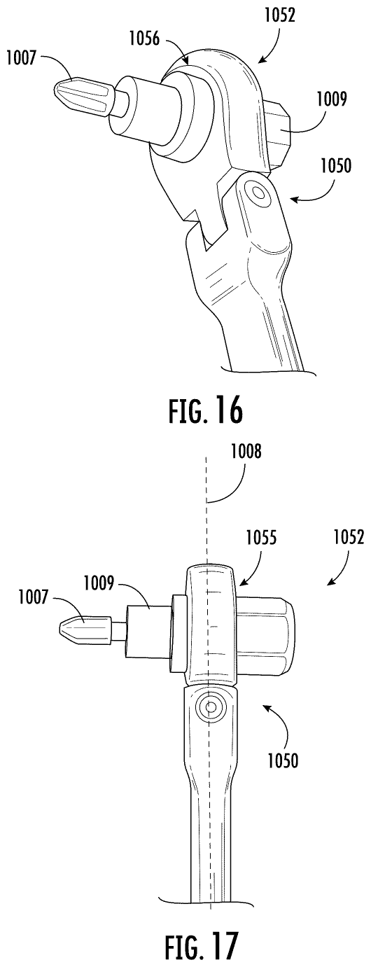

Referring to FIG. 15-17, a driving tool kit 1000 is shown. Driving tool kit 1000 is substantially the same as driving tool kits 500, 600, 700, 800, and 900 except for the differences discussed herein. Specifically, driving tool kit 1000 includes a first driver accessory, shown as a micro-ratchet attachment 1006 and a second driver accessory shown as a socket adapter 1009.

Driving tool kit 1000 includes a handle 1002, an end cap 1004, micro-ratchet attachment 1006, socket adapter 1009, and an engagement bit shown as screwdriver bit 1007. Micro-ratchet attachment 1006 includes a first end 1050 and a second end 1051 opposite first end 1050. Second end 1051 is removably coupled to a mounting end 1010 of handle 1002. A head 1052 of socket driver attachment 1006 is located at first end 1050. Head 1052 defines an opening 1056. Opening 1056 is configured to receive and retain an engagement bit or another driver accessory.

Socket adaptor 1009 is received and retained within opening 1056 and extends through opening 1056 in a direction substantially perpendicular to longitudinal axis 1008. Socket adapter 1009 has a length greater than the width of head 1052 such that a portion of socket adapter 1009 extends through opening 1056 and past a rear surface 1055 of head 1052. As shown, socket adaptor 1009 is a hex bit socket adapter and is configured to receive an engagement bit, such as a screwdriver bit. Socket adapter 1009 defines a hexagonal-shaped opening configured to engage with an engagement bit. Screwdriver bit 1007 is mounted on socker adapter 1009. Screwdriver bit 1007 is configured to engage with a workpiece (such as a fastener).

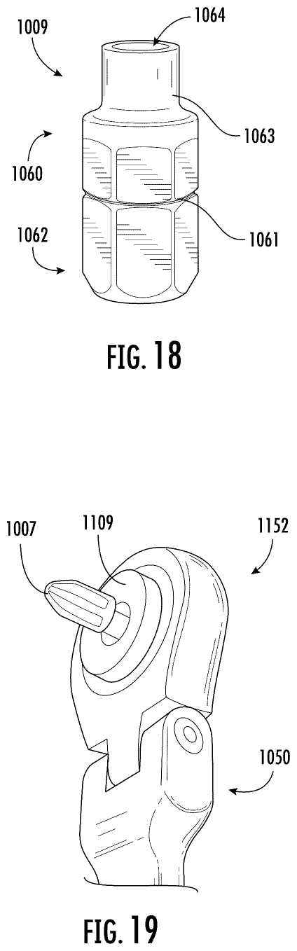

Referring to FIG. 18, socket adapter 1009 is shown. Socket adapter 1009 includes a body 1061 having a first end 1060 and a second end 1062. As shown body 1061 defines a hexagonal shape. First end 1060 is configured to engage with a workpiece or an engagement bit. As shown, first end 1060 includes a cylindrical protrusion 1063 and an opening 1064. When first end 1060 engages with a workpiece or an engagement bit, the workpiece (or engagement bit) is received within opening 1064 and surrounded by a portion of protrusion 1063.

Referring to FIGS. 19-20, a head 1152 of a ratchet attachment is shown. Head 1152 is substantially similar to head 1052. As shown, a socket adapter 1109 is received and retained within an opening 1156 defined by head 1152. Socket adapter 1109 is substantially the same as socket adapter 1009, except for the differences discussed herein. In particular, socket adapter 1109 has a body 1162. Body 1162 has a length that is closer to the width of head 1152. Screwdriver bit 1107 is mounted on socker adapter 1109. Screwdriver bit 1107 is configured to engage with a workpiece (such as a fastener).

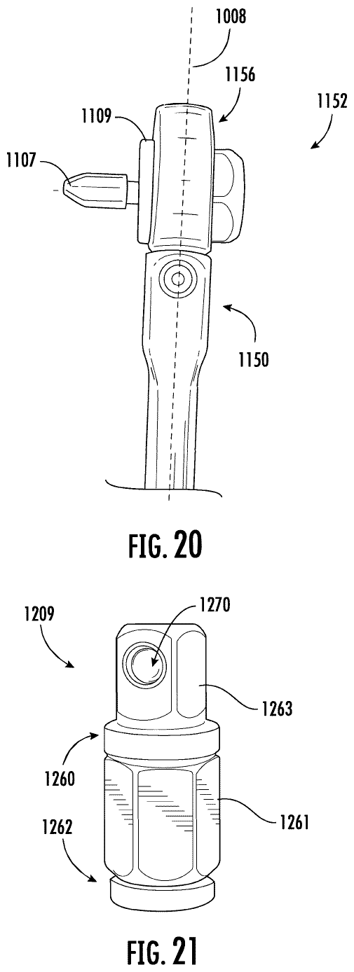

Referring to FIG. 21, a socket adapter 1209 is shown and described. Socket adapter 1209 is substantially the same as socket adapters 1009 and 1109, except for the differences discussed herein. Specifically, socket adapter 1209 has a protrusion 1263 at a first end 1260. Protrusion 1262 defines a closed end and includes a ball detent 1270 to assist in retaining engagement bits on first end 1260 of socket adapter 1209. Protrusion 1263 defines a hexagonal-shape and is configured to be inserted into a receiving end or open end of an engagement bit.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths, and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles, and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A driving tool, comprising:
a handle comprising:
a first end;
a second end opposite the first end along a longitudinal axis; and
an outer surface extending between the first end and the second end;
a channel centered on the longitudinal axis and extending along the length of the handle from the first end of the handle to the second end of the handle, the outer surface of the handle circumferentially surrounding the channel with respect to the longitudinal axis, the channel comprising:
a first opening located at the first end of the handle; and
a second opening opposite the first opening and located at the second end of the handle;
an end cap removably coupled to the second end of the handle, the end cap comprising a shaft, wherein the shaft extends through the second opening and is positioned within the channel when the end cap is coupled to the second end of the handle;
wherein, when the end cap is removed, the channel is configured to drive a fastener.

2. The driving tool of claim 1, wherein the channel is configured to drive a fastener along a workpiece when the workpiece is positioned within the channel.

3. The driving tool of claim 1, wherein the first opening is configured to receive and retain an engagement bit.

4. The driving tool of claim 1, further comprising an insert positioned within in the first opening, wherein the insert is configured to engage and retain a driver accessory.

5. The driving tool of claim 4, wherein the insert defines a hexagonal shaped interface.

6. The driving tool of claim 1, wherein the shaft of the end cap is configured to receive and retain at least one engagement bit.

7. The driving tool of claim 1, wherein an end of the shaft is configured to receive and retain a socket such that the socket is surrounded by the outer surface of the handle and positioned along the longitudinal axis when the end cap is coupled to the second end of the handle.

8. The driving tool of claim 1, wherein the shaft comprises a tip configured to engage a workpiece.

9. A driving tool, comprising:
a handle comprising:
a first end;
a second end opposite the first end along a longitudinal axis;
a body defining a cavity within the handle between the first end and the second end, the body comprising an outer surface circumferentially surrounding the cavity with respect to the longitudinal axis; and
an opening at the first end of the handle, the opening centered on the longitudinal axis and configured to engage a driver accessory;
an end cap coupled to the second end of the handle, the end cap comprising a shaft configured to engage and retain at least one engagement bit; and
a channel formed along the handle, the channel extending along the longitudinal axis from the opening through the cavity and to the second end of the handle, wherein when the end cap is removed, the channel is configured to engage a workpiece.

10. The driving tool of claim 9, wherein the cavity has a first width measured perpendicular to the longitudinal axis and the channel has a second width measured perpendicular to the longitudinal axis, wherein the first width is greater than the second width.

11. The driving tool of claim 9, wherein the end cap further comprises a pair of projections, wherein, when an engagement bit is placed between the pair of projections, the pair of projections retains the engagement bit on the end cap.

12. The driving tool of claim 9, wherein an end of the shaft is configured to receive and retain a socket.

13. The driving tool of claim 9, wherein the shaft comprises a tip configured to engage a workpiece.

14. The driving tool of claim 9, wherein the channel defines a cross-section that is a first shape, and the opening defines a second shape, wherein the first shape is different from the second shape.

15. The driving tool of claim 14, wherein the second shape is a hexagonal shape.

16. A driving tool kit, comprising:
at least one driver accessory;
at least one engagement bit;
a handle extending along a longitudinal axis, the handle comprising:
a first end;
a second end opposite the first end along the longitudinal axis;
an opening located at the first end of the handle, the opening configured to receive and retain the at least one driver accessory; and
a channel extending along the longitudinal axis between the first end and the second end, the channel surrounded by an outer surface of the handle; and
an end cap removably coupled to the second end of the handle, the end cap comprising a shaft extending into the channel of the handle when the end cap is coupled to the second end, wherein the shaft is configured to receive and retain the at least one engagement bit.

17. The driving tool kit of claim 16, wherein, when the end cap is removed, the channel is configured to drive a fastener.

18. The driving tool kit of claim 16, wherein the at least one driver accessory is a ratchet wrench attachment.

19. The driving tool kit of claim 16, wherein the at least one driver accessory is a socket adapter.

20. The driving tool kit of claim 19, wherein the at least one engagement bit is a socket and the shaft has an end shaped to engage and retain the socket.
